(19) United States
(12) Patent Application Publication
(10) Pub. No.: US 2019/0213022 A1
(43) Pub. Date: Jul. 11, 2019

(54) VEHICLE INFOTAINMENT SYSTEM

(71) Applicant: Ford Global Technologies, LLC, Dearborn, MI (US)

(72) Inventors: Hamid M. GOLGIRI, Dearborn, MI (US); Danielle ROSENBLATT, Dearborn, MI (US); Anthony MELATTI, Dearborn, MI (US); Patrick Lawrence Jackson VAN HOECKE, Dearborn, MI (US)

(21) Appl. No.: 15/868,514

(22) Filed: Jan. 11, 2018

(51) Int. Cl. G06F 9/451; B60K 35/00; G06F 3/147; G06F 17/30

(52) U.S. Cl. CPC G06F 9/453; B60K 35/00; B60K 2350/1096; G06F 17/30477; G06F 3/147

(57) ABSTRACT

Systems, methods, and vehicles include an in-vehicle infotainment system. The infotainment system includes a processor and a display. Responsive to a vehicle key cycle, the processor is programmed to perform a loading process for the infotainment system. The processor is further programmed to cause the display to show advice relating to the vehicle during the loading process.

### TECHNICAL FIELD

Aspects of this disclosure generally relate to vehicle infotainment systems.

### BACKGROUND

Vehicles often include infotainment systems that enable user interaction with various features of the vehicle.

### SUMMARY

In an exemplary embodiment, a vehicle includes an infotainment system having a display and a processor. Responsive to a vehicle key cycle, the processor is configured to perform a loading process for the infotainment system, and to cause the display to show advice relating to the vehicle during the loading process.

In another exemplary embodiment, a system includes a vehicle including an infotainment system. Responsive to a vehicle key cycle by a driver, the infotainment system is configured to perform a loading process for the infotainment system. The infotainment system is further configured to display advice relating to the vehicle during the loading process, the advice having been selected from a database including a plurality of advice proposals based on a vehicle history associated with the driver and an environmental condition of the vehicle.

In a further exemplary embodiment, a method includes, responsive to a vehicle key cycle, performing, by an infotainment system of the vehicle, a loading process for the infotainment system. The method further includes displaying advice relating to the vehicle during the loading process.

### BRIEF DESCRIPTION OF THE DRAWINGS

FIG. 1 is a schematic drawing of an exemplary system for implementing an in-vehicle infotainment system that provides a user with valuable information relating to the vehicle while the infotainment system is loading.

FIG. 2 is a flowchart of an exemplary process for identifying valuable information to present on an infotainment system while the infotainment system is loading that may be performed by the exemplary system of FIG. 1.

FIG. 3 is a flowchart of an exemplary process for providing valuable information on an infotainment system while the infotainment system is loading that may be performed by the exemplary system of FIG. 1.

FIG. 4 is an exemplary screenshot including valuable information relating to a vehicle that may be shown by the infotainment system of the vehicle when the infotainment system is loading.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A need exists for a vehicle infotainment system that provides a user with advice relating his or her vehicle in a manner that avoids significant interruption to the user's ability to otherwise utilize the infotainment system.

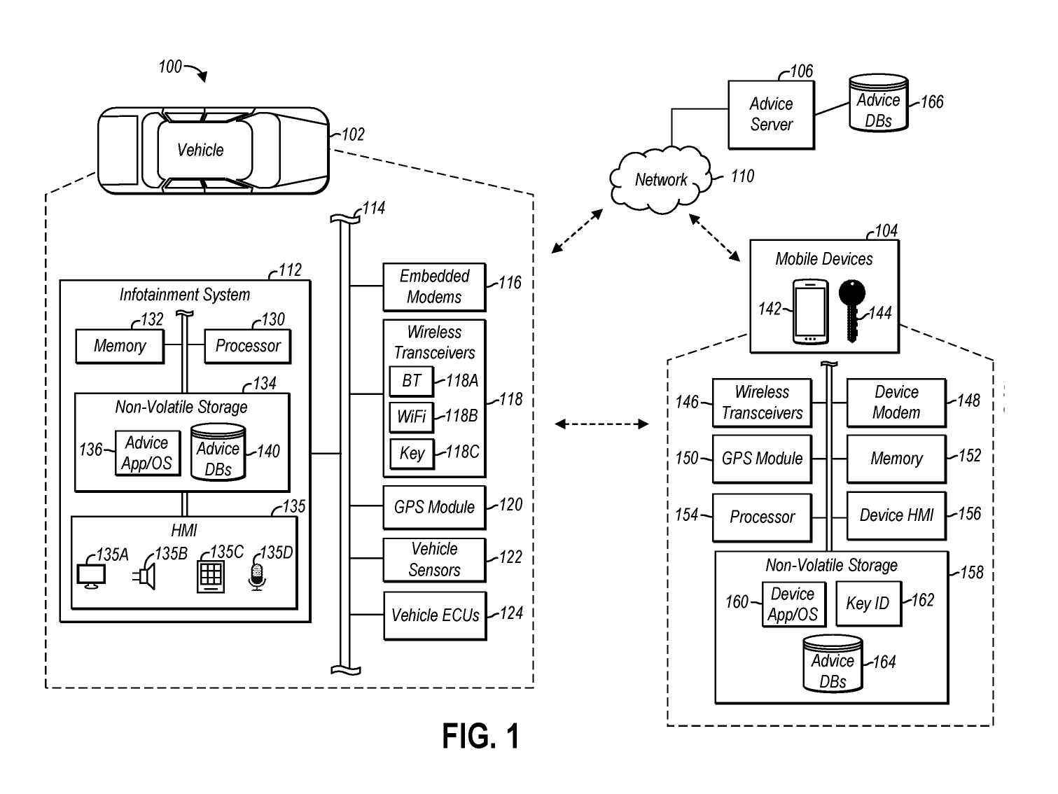

FIG. 1 illustrates a system 100 for implementing a vehicle infotainment system that provides users with valuable information relating to the vehicle while the infotainment system is loading. In particular, given the plethora of features included in modern vehicles, users often forget or are unware of valuable features offered by their vehicles. Although a description of such features may be provided in the vehicle's manual, such manuals are typically large and burdensome to review. Accordingly, the exemplary system 100 may be configured to provide advice to a user upon each vehicle key cycle. The advice may indicate a valuable and/or under-utilized vehicle feature. The particular feature that is highlighted to the user may be selected based on several parameters, such as an identity of the driver that performed the key cycle and a current vehicle condition.

The system 100 may be configured to show the advice via the in-vehicle infotainment system while the infotainment system is loading, which may occur immediately following the key cycle. In particular, the in-vehicle infotainment system may cause a display of the vehicle to show the advice during the loading process. Because the user may not be able to interact with the infotainment system during this loading process, showing the advice during this time generally does not interrupt a user's ability to utilize the infotainment system. Moreover, presenting the advice to the user immediately after a key cycle and during the loading process enables the user to quickly become aware of the advice at the beginning of vehicle operation and to view the advice in a simple format without being amidst a large amount of other distracting information.

The system 100 may include one or more of a vehicle 102, one or more mobile devices 104, and an advice server 106. Each of these system 100 components may communicate with one or more of the other system 100 components directly and/or over the network 110. The network 110 may include one or more interconnected communication networks, such as one or more of the Internet, a cable television distribution network, a satellite link network, a local area network, a wide area network, and a telephone network.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). The vehicle 102 may also be an autonomous vehicle (AV). As the type and configuration of vehicle 102 may vary, the capabilities of the vehicle 102 may correspondingly vary. For example, different vehicles 102 may have different capabilities with respect to passenger capacity, towing ability and capacity, and storage volume. For title, inventory, and other purposes, the vehicle 102 may be associated with and include thereon a unique identifier, such as a Vehicle Identification Number (“VIN”).

The vehicle 102 may include several components, such as an infotainment system 112, configured to perform functions in support of the processes described herein. Once loaded, the infotainment system 112 may be configured to provide entertainment and information content to a driver while he or she operates the vehicle 102. For example, the infotainment system 112 may be configured to provide a navigation service, manage and play audio content, facilitate hands-free phone calls, access and display Internet and smartphone content (e.g., traffic conditions, sports scores, weather forecasts), and collect and display vehicle 102 usage information (e.g., speed, mileage, gas range).

Responsive to a key cycle of the vehicle 102, the infotainment system 112 may be configured to a perform a loading process in which hardware is initialized and software is executed to ready provision of the aforementioned services. The infotainment system 112 may be configured to select and/or display advice relating to the vehicle 102 during this loading process. The advice may indicate an available feature of the vehicle 102 that has been underutilized or not utilized, such as remote start. The shown advice may be selected based on several parameters, such as a history of utilized vehicle features and/or a current environmental condition of the vehicle 102 (e.g., ambient temperature). By displaying such advice while the infotainment system 112 is loading, the infotainment system 112 provides valuable information to the user without significantly interrupting a user's ability to utilize the infotainment system 112.

The infotainment system 112 may communicate with other vehicle 102 components via one or more in-vehicle networks 114. The in-vehicle networks 114 may include one or more of a vehicle controller area network (“CAN”), an Ethernet network, and a media oriented system transfer (“MOST”) network. The other vehicle 102 components may include one or more of embedded modems 116, wireless transceivers 118, a global positioning satellite (“GPS”) module 120, vehicle sensors 122, and various vehicle electronic control units (“ECUs”) 124.

The embedded modems 116 may include one or more cellular modems configured to facilitate data and/or voice communications between the vehicle 102 and other system 100 components, such as the advice server 106, over the network 110. In particular, the cellular modems may connect the vehicle 102 to the Internet and/or a telephone network over a cellular network to which the modems are subscribed. The embedded modems 116 may thus enable communication between the vehicle 102 components and the advice server 106 over the Internet, and may enable data and voice communications between the vehicle 102 and the mobile devices 104 over the Internet and/or over a telephone network, in support of the processes described herein.

The wireless transceivers 118 may include one or more wireless transceivers that facilitate direct wireless communication between the vehicle 102 and other system 100 components when such components are local to (e.g., within wireless communication range of) the wireless transceivers 118. For example, a wireless transceiver 118 of the vehicle 102 may be configured to directly connect and communicate with a corresponding wireless transceiver 146 of a mobile device 104, and may thereby enable the vehicle 102 components to exchange data with the mobile device 104. This data exchange may enable the vehicle 102 to provide various features in cooperation with the mobile device 104 such as hands-free telephone service, keyless entry and/or passive entry passive start (“PEPS”), streaming music content stored on the mobile device 104, navigation, and in-vehicle applications reliant on content from the mobile device 104.

The vehicle 102 wireless transceivers 118 and the mobile device 104 wireless transceivers 146 may communicate via radio frequency (“RF”) transmissions. As some non-limiting examples, the vehicle 102 wireless transceivers 118 and the mobile device 104 wireless transceivers 146 may each include one or more of a Bluetooth transceiver 118A, a WiFi transceiver 118B, and keyless system transceivers 118C, the latter of which may be arranged around the vehicle 102 and may be configured with wireless protocols supportive of keyless entry and/or PEPS. For instance, relative to PEPS, a vehicle 102 keyless system transceiver 118C may be located near or within a vehicle 102 door handle. When a mobile device 104 keyless system transceiver 118C is within communication range of the vehicle 102 keyless system transceiver 118C of the door handle, the vehicle 102 may automatically unlock the vehicle 102 upon interaction with the vehicle 102 door handle. The vehicle 102 wireless transceivers 118 and the mobile device 104 wireless transceivers 146, or more particularly the keyless system transceivers 118C of each of these system 100 components, may include and operate via a radio-frequency identification (“RFID”) transceiver and/or a near-field communication (“NFC”) transceiver.

In some embodiments, in addition or alternatively to accessing the Internet and/or telephone network via the embedded modem 116, the vehicle 102 components may access the Internet and/or telephone network via the vehicle 102 wireless transceivers 118, the mobile device 104 wireless transceivers 146, and the Internet and/or telephone network connections of the mobile device 104. Specifically, the mobile device 104 may include a device modem 148 similar to a vehicle 102 embedded modem 116 that enables the mobile device 104 to access the Internet and/or a telephone network over a cellular network to which the device modem 148 is subscribed. When the vehicle 102 wireless transceivers 118 and the mobile device 104 wireless transceivers 146 form a local connection, such as via their Bluetooth transceivers 118A, the vehicle 102 wireless transceivers 118 may access the Internet and/or telephone network via the Internet and/or telephone network connection of the device modem 148.

The GPS module 120 of the vehicle 102 may be configured to identify vehicle 102 geographical data, such as via communicating with one or more satellites over the satellite link network of the network 110. The vehicle 102 geographical data may include a current latitude and longitude of the vehicle 102, and may include a current address of the vehicle 102. The GPS module 120 may provide the geographical data to another vehicle 102 component, such as the infotainment system 112, automatically or on request. For example, upon completion of its loading process, the infotainment system 112 may be configured to provide a navigation service to a driver based on geographical data received from the GPS module 120.

The vehicle sensors 122 may be arranged throughout the vehicle 102 and may be configured to generate signals indicative of current conditions of the vehicle 102, such as vehicle environmental conditions. For example, the vehicle sensors 122 may include one or more of a temperature sensor configured to sense and indicate an ambient temperature of the vehicle 102, a temperature sensor configured to sense and indicate an interior cabin temperature of the vehicle 102, and a precipitation sensor configured to sense and indicate current precipitation being experiences by the vehicle 102. As further examples, the vehicle sensors 122 may include a speed sensor configured to sense and indicate a current speed of the vehicle 102, an acceleration sensor configured to sense and indicate a current acceleration of the vehicle 102, and a fuel sensor configured to sense and indicate a remaining fuel level of the vehicle 102.

The vehicle ECUs 124 may be configured to monitor and manage various functions of the vehicle 102 under the power of the vehicle 102 battery and/or drivetrain. The vehicle ECUs 124 may be implemented by one or more processors and one or more electronic storage devices including computer-executable instructions that, upon execution by the one or more processors, cause the one or more processors to perform the functions of the vehicle ECUs 124. The vehicle ECUs 124 may include, but are not limited to, a powertrain controller configured to monitor manage engine operating components, a body controller configured to monitor and manage various power control functions such as exterior lighting, interior lighting, keyless entry, remote start, and point of access status verification, a radio transceiver controller configured to communicate with key fobs, mobile devices, or other local vehicle 102 devices, an entertainment controller configured to support voice command and Bluetooth interfaces with the driver and driver carry-on devices, and a climate management controller configured to monitor and manage heating and cooling system components (e.g., compressor clutch, blower fan, temperature sensors, etc.).

The infotainment system 112 may include a processor 130, memory 132, non-volatile storage 134, and a human machine interface (“HMI”) 135. The processor 130 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 132. The memory 132 may include a single memory device or a plurality of memory devices including, but not limited, random access memory (“RAM”), volatile memory, non-volatile memory, static random access memory (“SRAM”), dynamic random access memory (“DRAM”), flash memory, cache memory, or any other device capable of storing information. The non-volatile storage 134 may include one or more persistent data storage devices such as a hard drive, optical drive, tape drive, non-volatile solid state device, or any other device capable of persistently storing information.

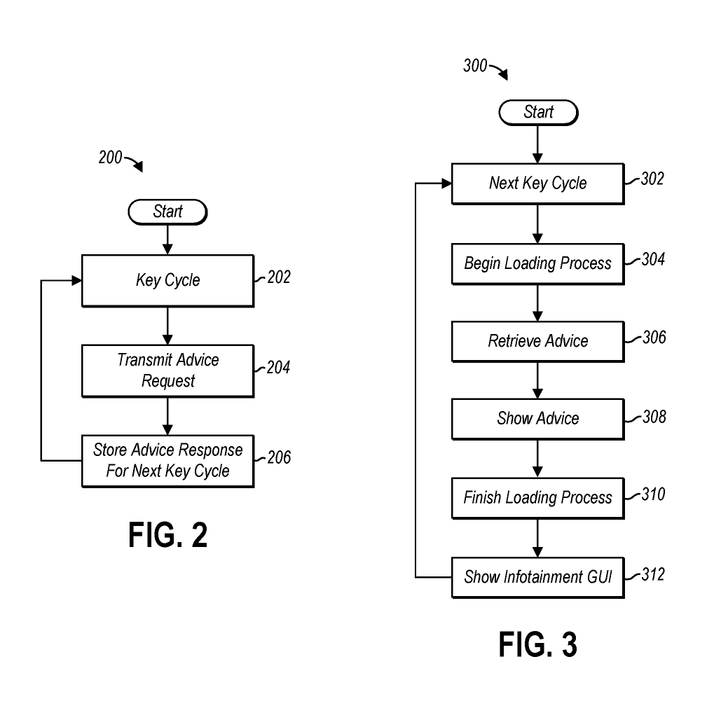

Responsive to a vehicle 102 key cycle, the processor 130 may be configured to read into memory 132 and execute computer-executable instructions embodied as an operating system (“OS”) residing in non-volatile storage 134. Upon execution by the processor 130, the OS may be configured to implement the functions, features, and processes of the infotainment system 112 described herein, and/or manage resources of the infotainment system 112 to enable the processor 130 to read into memory 132 and execute one or more software applications, such as the advice application, residing in non-volatile storage 134. Upon execution by the processor 130, the advice application may likewise be configured to implement functions, features, and processes of the infotainment system 112 described herein. For example, upon execution of advice application/OS 136, the processor 130 may perform one or more blocks of the of the processes 200 and 300 (FIGS. 2 and 3). In some embodiments, the processor 130 may be configured to execute the advice app directly, in which the OS may be omitted. The computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The non-volatile storage 134 may also include one or more databases, such as one or more advice databases 140, configured to collect and organize data used by the various systems, applications, and modules described herein. The databases may include data and supporting data structures that store and organize the data. In particular, the databases may be arranged with any database organization or structure including, but not limited to, a relational database, a hierarchical database, a network database, or combinations thereof. A database management system in the form of a computer software application executing as instructions on the processor 130 may be used to access the information or data stored in records of the database in response to a query, where a query may be dynamically determined and executed by the advice application/OS 136. In other words, upon execution of the advice application/OS 136, the processor 130 may access and retrieve data from the one or more advice databases 140 stored in the non-volatile storage 134 to support the functions, features, and processes described herein.

The HMI 135 may facilitate occupant interaction with the vehicle 102 components. The HMI 135 may receive input from and output information to a user. The HMI 135 may include one or more video and/or alphanumeric displays 135A, a speaker 135B, and any other suitable audio and visual indicators capable of providing data to the user. The displays 135A may include one or more touch screen displays capable of accepting input from a user, and may be positioned in a center console area of the vehicle 102 and/or in a gauge cluster area of the vehicle 102. The HMI 135 may also include controls 135C and a microphone 135D capable of accepting commands or input from a user to invoke functions of the vehicle 102. The controls 135C may include an alphanumeric keyboard, a pointing device, keypads, pushbuttons, control knobs, and/or touch sensors. For example, the controls 135C may include steering wheel audio buttons, a push-to-talk button, instrument panel controls, and the like.

The mobile devices 104 may include transient devices configured to communicate with and affect operation of the vehicle 102, such as a cellular mobile phone 142 or a key fob 144. Each mobile device 104 may include one or more of wireless transceivers 146, a device modem 148, a GPS module 150, memory 152, a processor 154, a device HMI 156, and non-volatile storage 158, each of which may be substantially similar to those of the vehicle 102. Accordingly, the mobile device 104 wireless transceivers 146 may include a Bluetooth transceiver 118A, a Wi-Fi transceiver 118B, and keyless system transceivers 118C, the device HMI 156 may include one or more of a display 135A, a speaker 135B, controls 135C, and a microphone 135D, and so on.

The mobile device 104 non-volatile storage 158 may include a device application/OS 160 that, upon execution by the mobile device 104 processor 154, causes the mobile device 104 processor 154 to implement the features, functions, and processes of the mobile device 104 that are described herein. The mobile device 104 non-volatile storage 158 may also include one or more advice databases 164 that are accessible by the executed device application/OS 160 to retrieve data in support of the features, functions, and processes described herein.

The mobile device 104 non-volatile storage 158 may also include a key ID 162 that the mobile device 104 may transmit to the vehicle 102, such as via the mobile device 104 wireless transceivers 146 and the vehicle 102 wireless transceivers 118, when the mobile device 104 is utilized for performing a vehicle 102 key cycle. A key cycle may occur when a user changes the vehicle 102 ignition to an accessory (“ACC”) mode, to a “start” mode, or to an “on” mode from an “off” mode, such as via inserting a mobile device 104 (e.g., a key fob 144) into the vehicle 102 ignition and turning the mobile device 104, or via interacting with a push start button when the mobile device 104 (e.g., a cellular mobile phone 142 or a key fob 144) is within local communication range of the vehicle 102 wireless transceivers 118 (e.g., the keyless system transceivers 118C). Responsive to attempting a key cycle, the mobile device 104 may be configured to transmit the key ID 162 of the mobile device 104 to the vehicle 102, and responsive to receiving the key ID 162, the vehicle 102, or more particularly one the vehicle ECUs 124 (e.g., the body controller), may be configured to determine whether the key ID 162 is registered with the vehicle 102. If so, then the vehicle ECU 124 may enable operation of the vehicle 102, such as by transmitting a corresponding signal to the other vehicle 102 components to power the vehicle 102 and start the vehicle 102 engine.

Multiple key IDs 162 may be registered with the vehicle 102 such that each registered key ID 162 is associated with a different mobile device 104 able to enable operation of the vehicle 102. Each mobile device 104 able to enable operation of the vehicle 102 may belong to a different user/driver. Accordingly, each key ID 162 of each mobile device 104 may represent a different driver that regularly utilized the vehicle 102.

The advice server 106 may be geographically remote from the vehicle 102 and the mobile devices 104. Although not shown, the advice server 106 may also include a processor, memory, and non-volatile storage including computer executable instructions that, upon execution by the advice server 106 processor, cause the advice server 106 to implement the features, functions, and processes of the advice server 106 described herein. The advice server 106 may further include hardware and/or software for connecting to the network 110, such as an Ethernet port, Wi-Fi transceiver, or a cellular modem. The advice server 106 may also include and/or have access to one or more advice databases 166, which may be accessed by the executed computer instructions to retrieve data in support of the features, functions, and processes of the advice server 106 described herein.

While an exemplary system 100 is shown in FIG. 1, the example is not intended to be limiting. Indeed, the system 100 may have more or fewer components, and alternative components and/or implementations may be used. For instance, in addition or alternatively to communicating via the in-vehicle networks 114, two or more vehicle 102 components may be directly connected. For example, a vehicle ECU 124 may be directly connected to one or more of the embedded modems 116 and/or the wireless transceivers 118 that support the functions of the vehicle ECU 124 (e.g., each of the body controller, radio transceiver controller, and/or the entertainment controller may be directly connected to the wireless transceivers 118 supporting the controller's functions), the infotainment system 112 may be directly connected to one or more of the vehicle ECUs 124, the embedded modems 116, and/or the wireless transceivers 118 that support the functions of the infotainment system 112, and additional vehicle 102 components may be directly connected to the HMI 135 to enable direct user interaction with the additional vehicle 102 components.

Exemplary operation of the system 100 will now be described with reference to the exemplary processes 200 and 300 (FIGS. 2 and 3). Referring first to the process 200 of FIG. 2, in block 202, a key cycle may occur for the vehicle 102. A key cycle may occur when a user changes the vehicle 102 ignition to an “Accessory” (“ACC”) mode, to a “Start” mode, or to an “On” mode from an “Off” mode, such as via inserting a key fob 144 into the vehicle 102 ignition and turning the key fob 144, or via interacting with a vehicle 102 push start button when a registered mobile device 104 (e.g., a mobile device 104 having a key ID 162 matching a key ID stored in the vehicle 102) is within communication range of the vehicle 102 wireless transceivers 118 (e.g., the keyless system transceivers 118C). Upon the key cycle being initiated, the mobile device 104 may be configured to transmit the key ID 162 of the mobile device 104 to the vehicle 102, such as via the mobile device 104 wireless transceivers 146 and the vehicle 102 wireless transceivers 118. The vehicle 102 may authorize the key cycle based on the received key ID 162 matching a key ID stored in the vehicle 102, and may transmit signal indicative of the key cycle and the key ID 162 to the infotainment system 112.

Responsive to the key cycle, in block 204, an advice request may be wirelessly transmitted offboard the vehicle 102 for a remote system, such as the advice server 106 or one of the mobile devices 104 (e.g., a cellular mobile phone 142). For example, the infotainment system 112 may cause the vehicle 102 to transmit the advice request to the advice server 106 over the Internet via the embedded modem 116, or to the cellular mobile phone 142 via the vehicle 102 wireless transceivers 118 and the mobile device 104 wireless transceivers 146 (e.g., via a Bluetooth connection formed between the vehicle 102 and the mobile device 104). In some embodiments, the infotainment system 112 may be configured to transmit the advice request responsive to the vehicle being turned off after the key cycle.

The advice request may include one or more parameters for selecting advice for the vehicle 102 to present to a user upon a next key cycle of the vehicle 102. More particularly, responsive receiving to the advice request, the mobile device 104 or the advice server 106 may query the one or more advice databases 164 or the one or more advice databases 166, respectively, to identify advice to be presented responsive to a next key cycle, or after a next key cycle by a mobile device 104 having the same key ID 162 as was used for the current key cycle. In this way, each driver may receive advice specific to the key ID 162 of the mobile device 104 of the driver.

The one or more parameters may include one or more of the VIN of the vehicle 102, a vehicle 102 condition as indicated by the vehicle sensors 122 (e.g., ambient temperature), and the key ID 162 received from the mobile device 104 during the key cycle, which may indicate the current driver and thus act as a driver identifier. Additionally, or alternatively, the one or more parameters may include a vehicle history associated with the received key ID 162. In particular, the infotainment system 112 one or more advice databases 140 may include a vehicle history for each key ID 162 registered to operate the vehicle 102.

The vehicle history may indicate one or more vehicle 102 features that have been utilized by a driver in connection with the key ID 162, such as within a last period immediately preceding the current key cycle, or one or more vehicle 102 features that have not been utilized in connection with the key ID 162 within a last period immediately preceding the current key cycle. For example, the vehicle history may include a list of vehicle 102 features, and a status associated with each vehicle 102 feature indicating use or non-use of the vehicle 102 feature within the last period. In addition, the vehicle history may include an indication of how each previously used vehicle 102 feature was used. For example, for a used vehicle 102 feature, the vehicle history may indicate when or how long ago the feature was used, how long the feature was used, and/or one or more sensed vehicle 102 conditions when the feature was used.

The last period may be in terms of a limited time (e.g., the last three months), may be in terms of a limited number of key cycles (e.g., the last one hundred key cycles), may be from the time the vehicle 102 became operational (e.g., indicating vehicle 102 features that have never been utilized), and/or may be from the time the vehicle 102 last changed ownership. To this end, the infotainment system 112 may include an option for resetting the vehicle history for each key ID 162, which a user may desire upon buying or selling the vehicle 102. For example, the vehicle history for a key ID 162 may indicate that adaptive cruise control (“ACC”) has not been utilized in connection a key ID 162 since the vehicle 102 last changed ownership three months ago.

The vehicle history may also include driving characteristics associated with the key ID 162, such as the number of accelerations occurring over a last period that have been larger than a set threshold value, and such as the amount of highway driving compared to city driving over a last period. The vehicle history may also indicate how many miles are on the vehicle 102, such as of the beginning of the current key cycle.

Responsive to receiving the key ID 162 from a key cycle, the infotainment system 112 may be configured to query the one or more advice databases 140 for the vehicle history associated with the key ID 162, and include the vehicle history in the advice request. Alternatively, the vehicle history for each key ID 162 registered with the vehicle 102 may be maintained by the mobile device 104 one or more advice databases 164 and/or the advice server 106 one or more advice databases 166, and may be updated each time the vehicle 102 is turned off In this case, responsive to receiving the key advice request from the vehicle 102, the mobile device 104 or the advice server 106 may be configured to query the one or more advice databases 164 or the one or more advice databases 166, respectively, for the driving history associated with the key ID 162.

In block 204, an advice response may be received and persistently stored, such as by the infotainment system 112 in the non-volatile storage 134. In particular, responsive to receiving the advice request, the mobile device 104 or the advice server 106 may be configured to query the one or more advice databases 164 or the one or more advice databases 166, respectively, based on the one or more search parameters of the advice request to select an advice proposal for an advice response sent back to the vehicle 102, such as via the Internet and the embedded modems 116 or via the vehicle 102 wireless transceivers 118. Responsive to receiving the advice response, the infotainment system 112 may be configured to persistently store the advice proposal of the advice response, such as in the non-volatile storage 134, as the advice to be shown upon a next key cycle, or upon a next key cycle by the same key ID 162 as the current key cycle.

The one or more advice databases 164 and the one or more advice databases 166 may each include several advice proposals for an advice response, each associated with one or more potential search parameters. One or several of the advice proposals may each indicate a feature of a vehicle, and may indicate where settings for the vehicle feature are located.

In some embodiments, the one or more advice databases 164 and/or the one or more advice databases 166 may include advice proposals having features of several different vehicles, where not every represented vehicle includes every included feature. Accordingly, each advice proposal may be associated within the one or more advice databases 164 and/or the one or more advice databases 166 with one or more VINs of vehicles that include the feature of the advice proposal, or with one or more key IDs 162 registered with a vehicle that includes the feature. In some embodiments, the advice server 106 may serve multiple vehicle types, and a given mobile device 104 may serve only the vehicle 102. In this case, the one or more advice databases 166 of the advice server 106 may include vehicle features from multiple vehicle types, and the one or more advice databases 164 of the mobile device 104 may be limited to including features of the vehicle 102. Thus, the VIN may be omitted from the one or more advice databases 164 of the mobile device 104 and the advice request sent thereto.

Each of the advice proposals may also be associated with a test to identify whether a sensed vehicle condition is present and/or to identify whether a particular vehicle history is present. For example, an advice proposal may be associated with a test of whether a current ambient temperature for the vehicle 102 is less than a predetermined value. As a further example, an advice proposal may be associated with a test of whether a driving characteristic is present in the vehicle history, such as at least a preset number of times, and/or whether a vehicle 102 feature has not been utilized according to the vehicle history for at least a predetermined period (e.g., since the vehicle 102 was built, since the vehicle 102 last changed ownership, the last three months, within three months since the vehicle 102 was built or last changed ownership) or in a certain manner (e.g., ACC has been utilized, but not in stop and go traffic). The associated tests may need to be satisfied for the advice proposal, and the vehicle feature of the advice proposal, to be returned in response to the query by the mobile device 104 or the advice server 106.

As some non-limiting examples, an advice proposal identifying a vehicle feature may be associated with a test of whether the vehicle history search parameter indicates the vehicle feature has not been utilized for at least a predetermine period. For instance, if the search parameters indicate that ACC has not been utilized for at least three months after the vehicle 102 last changed ownership, the one or more advice databases 164, 166 may return an advice proposal identifying ACC and indicating the location of settings for utilizing ACC. Another exemplary advice proposal may identify a vehicle feature and be associated with a test of whether the vehicle history parameter indicates the vehicle feature has not been utilized for at least a predetermined period and of whether the sensed condition parameter indicates a condition solved by the vehicle feature. For instance, if the search parameters indicate that the identified driver hasn't utilized remote start with heated seats for a predetermined period and that the current ambient temperature of the vehicle 102 is below a threshold value, the one or more advice databases 164, 166 may return an advice proposal identifying the vehicle 102 feature by which heated seats turn on when a remote start is conducted and a location of the settings for activating the vehicle 102 feature.

In some embodiments, the advice proposals of the one or more advice databases 164, 166 may also include efficiency proposals. The efficiency proposals may include advice for achieving better fuel efficiency and/or longevity of the vehicle 102, and may be associated with a test relating to whether a particular vehicle history is present. For example, an efficiency proposal recommending additional highway driving may be associated with a test for a vehicle history indicating an average fuel economy (e.g., miles per gallon) below a threshold value.

The one or more advice databases 164, 166 may also include manufacturer proposals. The manufacturer proposals may include facts about the manufacturer of the vehicle 102. The vehicle 102 and/or the mobile device 104 may be configured to select one of the manufacturer proposals periodically or at random for the advice response, either based on or regardless of the search parameters, over the advice proposals in the one or more advice databases 164, 166. For example, a manufacturer proposal may be associated with a vehicle history indicating a recurring vehicle activity (e.g., hauling, accelerations) or an upcoming potential purchase (e.g., mileage above a threshold), and may include a fact related to the associated recurring vehicle activity or an upcoming potential purchase (e.g. “Did you know that Manufacturer X is the number one truck company in the US?”).

In some embodiments, multiple proposals, which may include advice proposals and/or the manufacturing proposals, in the one or more advice databases 164, 166 may match the search parameters of the advice request. Accordingly, the proposals of the one or more advice databases 164, 166 may be ranked within the one or more advice databases 164, 166. In addition, the mobile device 104 and advice server 106 may be configured to keep track of which proposals were selected for a given key ID 162. Thus, if multiple proposals match the search parameters, those that have not yet been selected for a given key ID 162 may be selected over those that have previously been selected. If, after this filter, multiple proposals are still in the running for being selected, then matching proposals of a higher rank may be selected over those of a lower rank. If, after this filter, multiple matching proposals are still available for selection, then the mobile device 104 or the advice server 106 may execute a random number generator to select one of the multiple matching proposals for the advice response.

Responsive to receiving the advice response, the infotainment system 112 may persistently store the advice proposal of the advice response in the non-volatile storage 134 of the vehicle 102 as the advice to be shown on the display 135A next time a key cycle is performed, or next time a key cycle is performed with the specific key ID 162.

In some embodiments, rather than transmitting an advice request to a remote system, the infotainment system 112 may be configured to select and persistently store a proposal to show to the user upon a next key cycle, or upon a next key cycle by the key ID 162. To this end, the infotainment system 112 one or more advice databases 140 may include the same data and organization as that described above for the mobile device 104 one or more advice databases 164. Responsive to a key cycle, the infotainment system 112 may be configured to select a proposal from the one or more advice databases 140, such as based on the one or more search parameters as described above, and store the selected proposal in the non-volatile storage 134 as advice for display during a next key cycle. Alternatively, the infotainment system 112 may be configured to associated a flag in the one or more advice databases 140 with the selected proposal, and locate the flag upon a next key cycle or a next key cycle with the same key ID 162. Like the one or more advice databases 164, 168, the one or more advice databases 140 may be updated as needed with new proposals, such as via the embedded modem 116 from the advice server 106 over the Internet or via the wireless transceivers 118 from the mobile device 104 over a local wireless connection (e.g., Bluetooth).

After block 206, the process 200 may repeat for the next key cycle. In other words, responsive to each vehicle 102 key cycle, the infotainment system 112 may retrieve and store another proposal for display during a subsequent key cycle.

FIG. 3 illustrates a process 300 that may be performed by the system 100 for a subsequent key cycle after the key cycle of the process 200. In some embodiments, the process 300 may be performed upon the key cycle immediately subsequent to the process 200, regardless of the key ID 162 of the mobile device 104 performing the key cycle. In other embodiments, the process 300 may be performed upon a next key cycle by a mobile device 104 including a same key ID 162 as that of a mobile device 104 that performed a key cycle in the process 200.

Thus, in block 302, a key cycle may be performed, such as by a mobile device 104. Upon occurrence of the key cycle, one of the vehicle ECUs 124, such as the powertrain controller or the body controller, may transmit a signal indicative of the key cycle to the infotainment system 112. Block 302 may also include transmitting the key ID 162 of the mobile device 104 performing the key cycle, such as via the vehicle 102 wireless transceivers 118, to the infotainment system 112. In this way, the infotainment system 112 may select previously stored advice associated with the key ID 162 to display so as to provide a customized user experience.

In block 304, a loading process for the infotainment system 112 may begin. The loading process may include functions performed by the infotainment system 112, or more particularly by the processor 130 of the infotainment system 112, to initialize hardware and load software that enables user interaction with the infotainment system 112. For example, responsive to the key cycle, an internal power supply for the infotainment system 112 may be initialized to achieve power stabilization. Thereafter, the processor 130 of the infotainment system 112 may be powered up, and the processor 130 may locate and execute a basic input output system (“BIOS”) stored in the non-volatile storage 134 of the infotainment system 112. Upon execution, the BIOS may be configured to perform a power on self-test (“POST”) process, and may then be configured to detect, test, and initialize hardware such as hard drives, video cards, network cards, memory, and plug and play devices.

Thereafter, the BIOS may be configured to locate a bootable drive, and to cause the processor 130 to execute a boot loader stored in the bootable drive. Upon execution, the boot loader may cause the OS to initialize. While initializing, the OS may load drivers that enable the OS to communicate with hardware devices of the infotainment system 112 and the vehicle 102. Finally, the OS may cause a GUI to be displayed, such as via the display 135A, that enables a user to interact with the infotainment system 112. Specifically, the GUI may be integrated with the OS, or the OS may execute an application that includes the GUI.

In block 306, the infotainment system 112 may be configured to retrieve advice to show to the user, such as during the loading process and via the executed BIOS, boot loader, or OS. In particular, the processor 130 may be configured to retrieve the previously stored or flagged advice (e.g., advice stored or flagged in the process 200) from non-volatile storage 134, such as before the OS begins loading drivers but after the boot loader is executed. In some embodiments, the one or more advice databases 140 of non-volatile storage 134 may include multiple instances of previously stored or flagged advice, each associated with a different mobile device 104 key ID 162. In this case, the infotainment system 112 may be configured to retrieve the previously stored or flagged advice associated with the key ID 162 received in block 302. As a further alternative, rather than retrieving previously stored or flagged advice, the infotainment system 112 may be configured to dynamically select a proposal from the one or more advice databases 140 based on one or more search parameters, or wirelessly transmit an advice request and receive an advice response, as described above. In other words, rather than retrieving advice stored or flagged during a previous key cycle, the infotainment system 112 may be configured to, responsive to a key cycle, both determine the advice and display the advice, such as before the OS begins loading drivers.

Block 306 may further include scanning the in-vehicle networks 114 to collect information from vehicle ECUs 124 and/or vehicle sensors 122 that will be used to augment the retrieved or selected advice. For example, for a given selected advice proposal, the infotainment system 112 may be configured to include a current ambient temperature of the vehicle 102 as part of the advice shown to the user to further enforce the value of the vehicle 102 feature included in the advice.

In block 308, a screen including the retrieved advice may be shown to the user while the infotainment system 112 loading process is being performed. In particular, the infotainment system 112 may cause the display 135A of the vehicle 102 to show a screen including the advice. In some embodiments, the screen may be displayed while the OS is initializing and loading drivers before displaying the GUI. In other words, upon execution, the OS, boot loader, or an executed vehicle application may cause the screen to be displayed while the OS is loading so as to provide information to the user during a time in which the user is unable to interact with the infotainment system 112. Because the portion of the infotainment system 112 loading process prior to the OS initializing may be relatively short (e.g., about two (2) seconds) relative to the entire loading process, which may last about ten (10) seconds, presenting the advice to the user while the OS is initializing enables adequate time for the user to absorb the advice without significantly affecting the boot time of the infotainment system 112 or the user's ability to interact with the infotainment system 112.

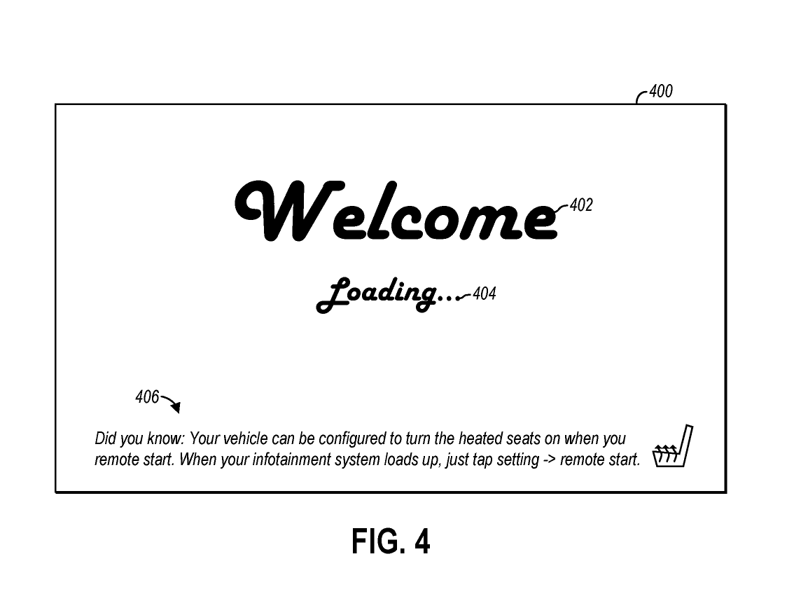

The screen may include a logo associated with the vehicle 102 and an indication that the infotainment system 112 is loading. For example, FIG. 4 illustrates a screen 400 and may be shown by the display 135A of the vehicle 102 during the loading process of the infotainment system 112. As shown in the illustrated embodiment, the screen 400 may include a welcoming graphic 402, a status graphic 404 indicating that the infotainment system 112 is undergoing the loading process, and an advice section 406 indicating the advice retrieved in block 304 of the process 300. In this case, the advice section 406 informs the user that a remote start command sent to the vehicle 102 can automatically cause the vehicle 102 to engage heated seats. The advice shown in the advice section 406 may have been selected based on parameters indicating that the remote start heated seat feature has not been utilized for at least predetermined period, and that the current ambient temperature for the vehicle 102 was recently (e.g., during the last key cycle) or is below a threshold value.

Referring again to FIG. 3, in block 310, the loading process for the infotainment system 112 may be completed. In block 312, responsive to the loading process being completed, the user may be given access to interact the infotainment system 112, such as via a GUI for the infotainment system 112 shown on the display 135A. After block 312, the process 300 may repeat for the next key cycle. In other words, responsive to each vehicle 102 key cycle, the infotainment system 112 may retrieve and display advice to a user during a loading process of the infotainment system 112.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
an infotainment system including a processor and a display, wherein responsive to a vehicle key cycle, the processor is programmed to
perform a loading process for the infotainment system; and
cause the display to show advice relating to the vehicle during the loading process.

2. The vehicle of claim 1, further comprising a database including a plurality of advice proposals, wherein responsive to the vehicle key cycle, the processor is programmed to select one of the advice proposals from the database for the shown advice based on a vehicle history associated with a driver that performed the vehicle key cycle.

3. The vehicle of claim 2, wherein the shown advice and the vehicle history each indicates a feature of the vehicle that has never been utilized by the driver.

4. The vehicle of claim 2, wherein the vehicle key cycle is a first vehicle key cycle, the database further includes a manufacturing proposal, and responsive to a second vehicle key cycle after the first vehicle key cycle, the processor is further programmed to
select the manufacturing proposal from the database;
perform the loading process for the infotainment system; and
cause the display to show the selected manufacturing proposal during the loading process.

5. The vehicle of claim 1, further comprising a database including a plurality of advice proposals, wherein responsive to the vehicle key cycle, the processor is programmed to select one of the advice proposals from the database for the shown advice based on a current environmental condition of the vehicle.

6. The vehicle of claim 5, wherein the current environmental condition of the vehicle is a current ambient temperature of the vehicle.

7. The vehicle of claim 1, wherein the processor is programmed to, during a last key cycle of the vehicle prior to the vehicle key cycle
wirelessly transmit an advice request to a remote system; and
persistently store an advice response wirelessly received from the remote system responsive to the advice request, the advice response including the advice shown on the display responsive to the vehicle key cycle.

8. The vehicle of claim 7, wherein the advice request includes one or more parameters that include one or more of a vehicle identification number, a vehicle environmental condition, and a driver identifier, and the remote system is programmed to select the advice response from a database including a plurality of advice response proposals based on the one or more parameters.

9. The vehicle of claim 7, further comprising a Bluetooth transceiver, wherein the advice response is wirelessly received from a mobile phone over the Bluetooth transceiver.

10. The vehicle of claim 7, further comprising an embedded modem programmed to connect to a cellular network, wherein the advice response is wirelessly received from a remote server over the cellular network and the embedded modem.

11. A system comprising:
a vehicle including an infotainment system, wherein responsive to a vehicle key cycle by a driver, the infotainment system is configured to
perform a loading process for the infotainment system; and
display advice relating to the vehicle during the loading process, the advice having been selected from a database including a plurality of advice proposals based on a vehicle history associated with the driver and an environmental condition of the vehicle.

12. The system of claim 11, wherein the advice and the vehicle history each indicates a feature of the vehicle that has never been utilized by the driver.

13. The system of claim 11, wherein the environmental condition of the vehicle is a current ambient temperature of the vehicle.

14. The system of claim 11, wherein the vehicle includes the database, and responsive to the vehicle key cycle, the infotainment system is further configured to select the advice from the database based on the vehicle history and the environmental condition of the vehicle.

15. The system of claim 11, wherein the vehicle key cycle is a first vehicle key cycle, the vehicle includes the database, and responsive to a second vehicle key cycle preceding the first vehicle key cycle, the infotainment system is further configured to, before the first vehicle key cycle,
select the advice from the database based on vehicle history and the environmental condition of the vehicle; and
persistently store the advice in the vehicle for display by the infotainment system responsive to the first vehicle key cycle.

16. The system of claim 11, wherein the vehicle key cycle is a first vehicle key cycle, and further comprising a server geographically remote from the vehicle and including the database, wherein the infotainment system is further configured to, responsive to a second vehicle key cycle prior to the first vehicle key cycle, wirelessly transmit an advice request to the server, and responsive to receiving the advice request, the server is configured to,
select the advice from the database based on vehicle history and the environmental condition of the vehicle; and
transmit an advice response to the infotainment system, the advice response including the selected advice, wherein upon receipt of the advice response, the infotainment system is configured to persistently store the selected advice of the advice response for display by the infotainment system responsive to the first vehicle key cycle.

17. A method comprising:
responsive to a vehicle key cycle, by an infotainment system of a vehicle,
performing a loading process for the infotainment system; and
displaying advice relating to the vehicle during the loading process.

18. The method of claim 17, wherein the vehicle key cycle is a first vehicle key cycle, and further comprising, responsive to a second vehicle key cycle preceding the first vehicle key cycle,
selecting the advice from a database including a plurality of advice proposals based on a vehicle history associated with a driver performing the first vehicle key cycle and the second vehicle key cycle and an environmental condition of the vehicle before the first vehicle key cycle; and
persistently storing the advice for display by the infotainment system responsive to the first vehicle key cycle.

19. The method of claim 17, wherein the vehicle key cycle is a first vehicle key cycle, and further comprising, responsive to a second vehicle key cycle preceding the first vehicle key cycle,
wirelessly transmitting an advice request to a server geographically remote from the vehicle; and
persistently storing an advice response wirelessly received from the server responsive to the advice request, the advice response including the advice displayed by the infotainment system responsive to the first vehicle key cycle.

20. The method of claim 19, wherein the advice request includes one or more parameters that include one or more of a vehicle identification number, a vehicle environmental condition, and a driver identifier, and the server is configured to select the advice response from a database including a plurality of advice proposals based on the one or more parameters.
